(19) United States
(12) Patent Application Publication
(10) Pub. No.: US 2006/0269809 A1
(43) Pub. Date: Nov. 30, 2006

(54) COOLING APPARATUS FOR FUEL CELL VEHICLE

(75) Inventors: Hideo Sakai, Wako-shi, Saitama (JP); Takayuki Ogawa, Wako-shi, Saitama (JP); Mitsuharu Imaseki, Wako-shi, Saitama (JP); Tomoya Yamagishi, Wako-shi, Saitama (JP); Kensaku Yamamoto, Wako-shi, Saitama (JP); Tohru Ono, Wako-shi, Saitama (JP); Kengo Takamizawa, Wako-shi, Saitama (JP)

Correspondence Address: RANKIN, HILL, PORTER & CLARK LLP, 4080 ERIE STREET, WILLOUGHBY, OH, 44094-7836, US

(73) Assignee: HONDA MOTOR CO., LTD., Tokyo (JP)

(21) Appl. No.: 11/419,897

(22) Filed: May 23, 2006

(30) Foreign Application Priority Data
May 24, 2005 (JP) 2005-151357

(51) Int. Cl. H01M 8/04; F28D 1/00

(52) U.S. Cl. 429/26; 429/24; 429/35; 165/148

(57) ABSTRACT

A cooling apparatus for a fuel cell vehicle for cooling a fuel cell and a drive motor that receives electric power from the fuel cell and produces motive power for traveling. The cooling apparatus is provided with a first radiator for cooling the fuel cell, a second radiator for cooling the drive motor, and a radiator air-cooling fan that is shared by the first and second radiators. The sizes of the ventilation apertures of the first radiator and second radiator are set to be essentially the same, and the heat-releasing surface areas are set so as to be different from each other. The first and second radiators are adjacent to each other in the front-rear direction of the vehicle and can be disposed in the front portion of the fuel cell vehicle. The periphery between the first radiator and the second radiator is sealed with a seal member.

### FIELD OF THE INVENTION

The present invention relates to a cooling apparatus for a fuel cell vehicle, used to cool the fuel cells mounted on the vehicle and to cool the drive motor that receives electric power from the fuel cell and generates motive power for traveling.

### BACKGROUND OF THE INVENTION

In recent years, the development of cooling apparatuses for cooling fuel cells and drive motors is being advanced in accompaniment with the development of fuel cell vehicles. JP-A-2000-315513 proposes a technique for mutually isolating and cooling the fuel cells and drive motors in order to manage a temperature difference between a fuel cell and a drive motor.

A general overview of the cooling apparatus for a fuel cell vehicle disclosed in JP-A-2000-315513 is described below with reference to FIG. 7 hereof

The cooling apparatus for a fuel cell vehicle 100 shown in FIG. 7 is configured with a first cooling line 110 for cooling a fuel cell 101 by a coolant (cooling medium), and a second cooling line 120 for cooling a drive motor 102 by a coolant (cooling medium). The lines are independent of each other. The drive motor 102 receives electric power from fuel cell 101 and generates motive power for traveling. The first cooling line 110 is provided with a first radiator 111 for cooling the fuel cell 101 by the coolant, and a coolant pump 113 for circulating the coolant. The second cooling line 120 is provided with a second radiator 121 for cooling the drive motor 102 by the coolant, and a coolant pump 123 for circulating the coolant.

The first radiator 111 is disposed further downstream in the cooling air than the second radiator 121. A plurality of radiator air-cooling fans 112 and 112 for cooling the first and second radiators 111 and 121 are disposed immediately behind (downstream in the cooling air) the first radiator 111.

A first cooling line 110 and a second cooling line 120 can be interconnected by way of two bypass lines 133 and 134 by switching two three-way valves 131 and 132. The second cooling line 120 is capable of cooling a controller 135 and an intercooler 136 for the compressor.

The operating temperature of the fuel cell 101 is 70 to 90° C. in the particular case that the fuel cell 101 is composed of a solid polymer fuel cell, and this temperature is lower than the operating temperature of an engine mounted in a common vehicle. Also the temperature difference between the operating temperature of the fuel cell 101 and the outside temperature is small. The heat-releasing surface area must be increased in order to increase the amount of heat released by the first radiator 111 for cooling the fuel cell 101, which has a lower operating temperature than the engine. As a result, the first radiator 111 must be made larger. There is room for improvement in disposing a large first radiator 111 in the narrow space of a fuel cell vehicle.

There is also a need to separately control the operating temperature of the fuel cell 101 and drive motor 102. Therefore, the second radiator 121 for cooling the coolant of the drive motor 102 is needed apart from the first radiator 111. For this reason, there is a need for a technique for separately cooling the fuel cell 101 and drive motor 102 with good efficiency.

In view of the above, there is needed whereby a plurality of radiators can be disposed in a narrow space, and the fuel cell and drive motor can be cooled with good efficiency.

### SUMMARY OF THE INVENTION

According to a first aspect of the present invention, there is provided a cooling apparatus for a fuel cell vehicle, which comprises a coolant-cooling first radiator for cooling a fuel cell, the first radiator having ventilation apertures and a heat-releasing surface area, a coolant-cooling second radiator for cooling a drive motor that receives electric power from said fuel cell and generates traveling motive power, the second radiator having ventilation apertures and a heat-releasing surface area, and a common radiator air-cooling fan for supplying cooling air to both the first and second radiators, wherein the ventilation apertures of the first radiator and the ventilation apertures of the second radiator are set to be substantially the same in size, the heat-releasing surface area of the first radiator and the heat-releasing surface area of the second radiator are set to be different from each other, the first and second radiators are capable of being disposed adjacent to each other forward of the fuel cell vehicle in the front-rear direction of the vehicle, and a periphery between the first radiator and the second radiator is sealed with a sealing member.

Thus, in the cooling apparatus for a fuel cell vehicle of the first aspect of the present invention, the sizes of the ventilation apertures of the first and second radiators are set to be essentially the same, the heat-releasing surface areas of the first and second radiators are set so as to be different from each other, and the first and second radiators are disposed adjacent to each other in the front-rear direction of the vehicle. Therefore, (1) the size of the ventilation apertures and the heat-releasing surface area are first established for the first radiator that cools the coolant for the fuel cell, which releases a considerable amount of heat, (2) the size of the ventilation apertures of the second radiator that cools the coolant for the drive motor, which releases a lower amount of heat, is thereafter set in accordance with the ventilation apertures of the first radiator, and (3) the heat-releasing surface area of the second radiator can be set to a size that corresponds to the amount of heat released by the drive motor.

More specifically, the sizes of the ventilation apertures of the first and second radiators can be set to be essentially equal to each other, and the heat-releasing surface areas of the first and second radiators can be individually set so as to achieve optimal surface areas. The pressure loss (ventilation resistance) of the cooling wind that passes through the first and second radiators is therefore dramatically reduced despite the fact that the first and second radiators are adjacent in the front-rear direction.

The sizes of the ventilation apertures of the first and second radiators are furthermore set to be substantially equal to each other. Therefore, the periphery between the adjacent surfaces can be reliably and readily sealed by placing the first and second radiators adjacent in the front-back direction of the vehicle. As a result, cooling air can be prevented from leaking from between the first and second radiators.

Moreover, since the first and second radiators are disposed in the front portion of the fuel cell vehicle, the ventilation air created when the fuel cell vehicle travels can be used effectively.

As a result of the above, it is possible to obtain an adequate amount of cooling air required for releasing the heat of the first and second radiators.

Also, since the first and second radiators are adjacent in the front-back direction of the vehicle, the installation space of the radiators can be kept low. For this reason, the first and second radiators can be easily disposed in the narrow space of the front portion of a fuel cell vehicle. A plurality of radiators can therefore be disposed in a small installation space, and the fuel cells and drive motor can be cooled with good efficiency.

Further space-savings can be assured because the radiator air-cooling fan for feeding cool air to the first and second radiators is shared by the first and second radiators.

Preferably, an operating temperature of the fuel cells is set to a higher level than is an operating temperature of the drive motor, while the first radiator is disposed behind the second radiator. For this reason, the cooling performance of the second radiator is not affected by the heat release of the first radiator, and the cooling capacity of the second radiator can be reduced.

Desirably, the apparatus further comprises a coolant-cooling third radiator for an interior air conditioner of the fuel cell vehicle. The third radiator may be disposed in front of the first and second radiators and have ventilation apertures sized substantially the same as the ventilation apertures of the first and second radiators, so that the common radiator air-cooling fan supplies cooling air to the third radiator.

For this reason, a third radiator for the interior air conditioner of a vehicle can be easily disposed together with the first and second radiators in the narrow space of the front portion of a fuel cell vehicle.

The size of the ventilation apertures of the third radiator is furthermore set to be substantially the same as the size of the ventilation apertures of the first and second radiators. For this reason, the periphery between the third radiator and the first and second radiators can be easily and reliably sealed with a seal member by placing the third radiator adjacent to the first and second radiators. As a result, leakage of the cooling air from between the third radiator and the first and second radiators can be prevented. Because of the above, the required amount of cooling air for releasing the heat of the first, second, and third radiators can be sufficiently assured.

Moreover, since the radiator air-cooling fan doubles as a fan for feeding cooling air to the third radiator, a cooling fan is not required to be separately provided for the third radiator. For this reason, further space-savings can be ensured.

Preferably, the third radiator has a thickness set to be less than a thickness of the first radiator, while the second radiator has a thickness set to be less than the thickness of the third radiator.

In a preferred form, each of the first, second and third radiators comprises a pair of lower-portion support pins on the left and right extending downward from the left end and the right end, and a pair of upper-portion support pins on the left and right extending upward from the left end and the right end. The pairs of the lower-portion support pins in the first, second and third radiators can be mounted on the chassis by fitting into a plurality of support holes that are provided to the chassis in the fuel cell vehicle, while the pairs of the upper-portion support pins in the first, second and third radiators can be mounted on the chassis by fitting into a plurality of support holes that are provided to a detachable linking member mounted on the chassis.

According to a second aspect of the present invention, there is provided a cooling apparatus for a fuel cell vehicle, which comprises a coolant-cooling first radiator for cooling a fuel cell, the first radiator having ventilation apertures and a heat-releasing surface area, a coolant-cooling second radiator for cooling a drive motor that receives electric power from said fuel cell and generates traveling motive power, the second radiator having ventilation apertures and a heat-releasing surface area, and a common radiator air-cooling fan, wherein the ventilation apertures of the first radiator and the ventilation apertures of the second radiator are set to be substantially the same in size, the heat-releasing surface area of the second radiator is set to be less than the heat-releasing surface area of the first radiator by setting a pitch of heat-releasing fins provided to the second radiator to be greater than a pitch of heat-releasing fins provided to the first radiator, the first and second radiators are capable of being disposed in the front portion of the fuel cell vehicle, the first radiator is disposed adjacent to a rear surface of the second radiator, a periphery between the first radiator and the second radiator is sealed with a sealing member, and the common radiator air-cooling fan supplies cooling air to both the first and second radiators by being mounted rearward of the first radiator.

Thus, in the cooling apparatus for a fuel cell vehicle of the second aspect of the present invention, the sizes of the ventilation apertures of the first and second radiators are set to be essentially the same, and the heat-releasing surface area of the second radiator is set to be less than the heat-releasing surface area of the first radiator by setting the pitch of the heat-releasing fins provided to the second radiator to be greater than the pitch of the heat-releasing fins provided to the first radiator. Therefore, (1) the size of the ventilation apertures and the heat-releasing surface area are first established for the first radiator that cools the coolant for the fuel cell, which releases a considerable amount of heat, (2) the size of the ventilation apertures of the second radiator that cools the coolant for the drive motor, which releases a lower amount of heat, is thereafter set in accordance with the ventilation apertures of the first radiator, and (3) the heat-releasing surface area of the second radiator can be set to a size that corresponds to the amount of heat released by the drive motor.

More specifically, the sizes of the ventilation apertures of the first and second radiators can be set to be substantially equal to each other, and the pitch of the heat-releasing fins in the first and second radiators can be individually set so that the heat-releasing surface areas of the first and second radiators are each set so as to achieve optimal surface areas. The first and second radiators are disposed in the front portion of the fuel cell vehicle and that the pressure loss (ventilation resistance) of the cooling wind that passes through the first and second radiators is therefore dramatically reduced despite the fact that the first radiator is disposed adjacent to the rear surface of the second radiator.

The sizes of the ventilation apertures of the first and second radiators are furthermore set to be substantially equal to each other. Therefore, the periphery between the adjacent surfaces can be reliably and readily sealed by placing the first and second radiators adjacent in the front-back direction of the vehicle. As a result, cooling air can be prevented from leaking from between the first and second radiators.

Moreover, since the first and second radiators are disposed in the front portion of the fuel cell vehicle, the ventilation air that is created when the fuel cell vehicle travels can be used effectively.

As a result of the above, an adequate amount of cooling air required for releasing heat can be obtained with the first and second radiators.

Also, since the first and second radiators are adjacent in the front-back direction of the vehicle, the installation space of the radiators can be kept low. For this reason, the first and second radiators can be easily disposed in the narrow space of the front portion of a fuel cell vehicle. A plurality of radiators can therefore be disposed in a small installation space, and the fuel cells and drive motor can be cooled with good efficiency.

Further space-savings can be assured because the radiator air-cooling fan for feeding cool air to the first and second radiators is shared by the first and second radiators.

Preferably, the apparatus further comprises a coolant-cooling third radiator for an interior air conditioner of the fuel cell vehicle, which are disposed in front of the first and second radiators. The ventilation apertures of the third radiator may be sized substantially the same as the ventilation apertures of the first and second radiators, so that the common radiator air-cooling fan supplies cooling air to the third radiator.

As a result, the third radiator for the interior air conditioner of the vehicle can be easily disposed together with the first and second radiators in the narrow space of the front portion of a fuel cell vehicle.

By virtue of the ventilation apertures of the third radiator being set to be substantially the same as the size of the ventilation apertures of the first and second radiators, the periphery between the third radiator and the first and second radiators can be easily and reliably sealed with a seal member by placing the third radiator adjacent to the first and second radiators. As a result, leakage of the cooling air from between the third radiator and the first and second radiators can be prevented. Because of the above, the required amount of cooling air for releasing the heat of the first, second, and third radiators can be sufficiently assured.

Moreover, since the common radiator air-cooling fan also supplies cooling air to the third radiator, a cooling fan is not required to be separately provided for the third radiator. For this reason, further space-savings can be ensured.

Preferably, the third radiator has a thickness set to be less than a thickness of the first radiator, while the second radiator have a thickness set to be less than the thickness of the third radiator.

Desirably, each of the first, second and third radiators comprises a pair of lower-portion support pins on the left and right extending downward from the left end and the right end, and a pair of upper-portion support pins on the left and right extending upward from the left end and the right end. The pairs of the lower-portion support pins in the first, second and third radiators are capable of being mounted on the chassis by fitting into a plurality of support holes that are provided to the chassis in the fuel cell vehicle, while the pairs of the upper-portion support pins in the first, second and third radiators are capable of being mounted on the chassis by fitting into a plurality of support holes that are provided to a detachable linking member mounted on the chassis.

### BRIEF DESCRIPTION OF THE DRAWINGS

Certain preferred embodiments of the present invention are described in detail below, by way of example only, with reference to the accompanying drawings, in which:

FIG. 1 is schematic view of the fuel cell vehicle of the present invention;

FIG. 2 is a system diagram of the cooling apparatus for a fuel cell vehicle shown in FIG. 1;

FIG. 3 is a schematic view of the first, second, and third radiators illustrated in FIG. 1;

FIG. 4 is a view of the front portion of the fuel cell vehicle depicted in FIG. 1, and the first, second, and third radiators disposed in the front portion of the vehicle;

FIG. 5 is an exploded view of the first, second, and third radiators and the left corner portion of the front of the chassis in the fuel cell vehicle shown in FIG. 1;

FIG. 6 is a partially assembled view of the first, second, and third radiators and the corner portion of the front of the chassis shown in FIG. 5; and

FIG. 7 is a system diagram of a conventional cooling apparatus for a fuel cell vehicle.

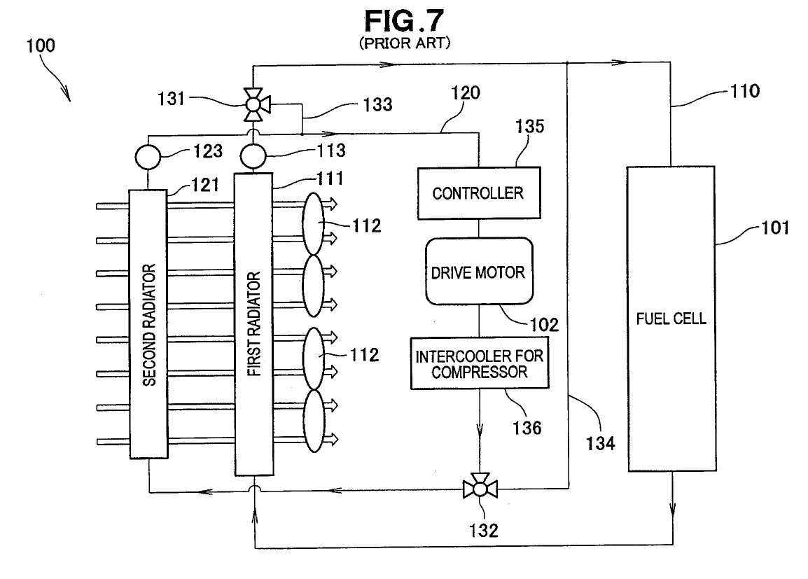

### DETAILED DESCRIPTION OF THE PREFERRED EMBODIMENTS

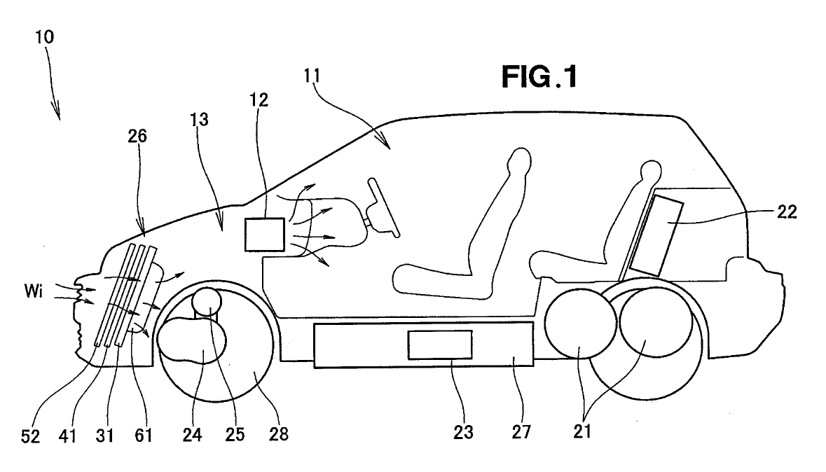

A fuel cell vehicle 10 is an automobile in which a fuel cell is mounted. The vehicle has an air-conditioner 12 for air-conditioning (at least one of cooling, or heating and cooling) the vehicle interior 11, a capacitor 22 and two hydrogen tanks 21 and 21 disposed in the rear portion of the chassis, a fuel cell 23 disposed under the floor in the center of the chassis, a drive motor 24 disposed in the power plant compartment 13 in the front portion of the chassis, an air pump 25, and a cooling apparatus 26, as shown in FIG. 1.

The capacitor 22 may be one that can store power, and includes a storage battery.

The fuel cell 23 is composed of a stack of a plurality of solid polymer fuel cells, and is housed in a system box (fuel cell case) 27. The fuel cell 23 generates electricity by electrochemical reaction between oxygen in air fed from an air pump 25 and hydrogen fed from hydrogen tanks 21 and 21.

A portion of the electricity generated by the fuel cell 23 is temporarily stored in the capacitor 22. Power is fed from the capacitor 22 to the drive motor 24 when the output of the fuel cell 23 is insufficient, and at other times. The drive motor 24 receives power from the fuel cell 23 and the capacitor 22, produces the motive power for the wheels 28, and has a transmission (not shown).

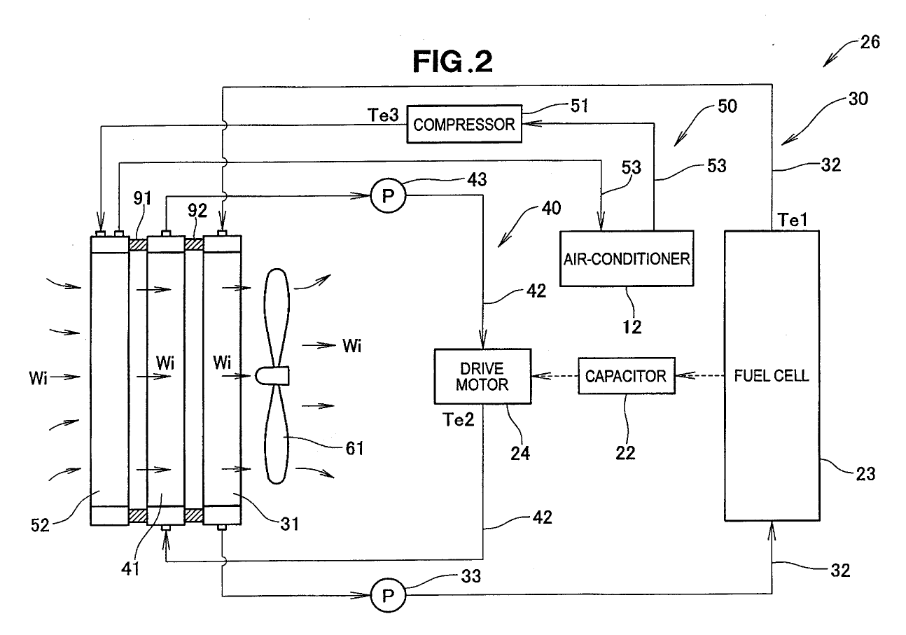

The cooling apparatus 26 is composed of a first cooling line 30 for cooling the fuel cell 23 with coolant, a second cooling line 40 for cooling the drive motor 24 with coolant, a third cooling line 50 for cooling the air-conditioner 12 with coolant, and a radiator air-cooling fan 61, as shown FIG. 2. The first, second, and third cooling lines 30, 40, and 50 are mutually independent. The coolant is cooling water, for example.

The first cooling line 30 is a line system connected by way of a first pipe arrangement 32 so as to allow coolant to circulate between the fuel cell 23 and first radiator 31, and is provided with a first coolant-circulating cooling pump 33. The first radiator 31 releases heat from the fuel cell 23 to the atmosphere by exchanging heat via the coolant.

The second cooling line 40 is a line system connected by way of a second pipe arrangement 42 so as to allow coolant to circulate between the drive motor 24 and second radiator 41, and is provided with a second coolant-circulating cooling pump 43. The second radiator 41 releases heat from the drive motor 24 to the atmosphere by exchanging heat via the coolant.

The third cooling line 50 is a general cooling system that is based on the vapor compression refrigeration principle and is connected by way of a third pipe arrangement 53 so as to allow coolant to circulate between the compressor 51, the third radiator 52, and an evaporator (not shown) housed in the air-conditioner 12. The third radiator 52 releases heat from the coolant to the atmosphere by exchanging heat with a high-temperature, high-pressure gaseous coolant that has been compressed in the compressor 51. The third radiator 52 may also be applied to an air conditioner in which carbon dioxide (CO₂) is used.

The radiator air-cooling fan 61 is a single fan that is shared by the first and second radiators 31 and 41 in order to feed cooling air Wi to the first and second radiators 31 and 41. The radiator air-cooling fan 61 doubles as a fan for feeding cooling air Wi to the third radiator 52.

In a normal state, the operating temperature (heat release temperature) Te1 of the fuel cell 23 is 80 to 90° C., and the operating temperature Te2 of the drive motor 24 is 60 to 70° C. The operating temperature Te3 of the compressor 51 is 50 to 55° C. when the air conditioner 12 is operating.

Thus, the operating temperature Te1 of the fuel cell 23 is set to be higher than the operating temperature Te2 of the drive motor 24. The operating temperature Te2 of the drive motor 24 is set to be higher than the operating temperature Te3 of the compressor 51. In other words, the relationship is set as follows: Te1>Te2>Te3.

The third radiator 52, second radiator 41, first radiator 31, and radiator air-cooling fan 61 are mounted in the fuel cell vehicle 10 by being arranged adjacent to each other in the stated order in the front portion of the fuel cell vehicle 10 from the front to the back in the front-rear direction of the vehicle, as shown in FIGS. 1 and 2.

More specifically, the second radiator 41 is disposed in the front portion of the fuel cell vehicle 10, the first radiator 31 is disposed behind the second radiator 41, and the radiator air-cooling fan 61 is disposed behind the first radiator 31. On the other hand, the third radiator 52 is disposed in front of the second radiator 41. The ventilation apertures of all of the radiators 52, 41, and 31 face forward so that the cooling air Wi introduced from the forward direction of the fuel cell vehicle 10 flows directly rearward.

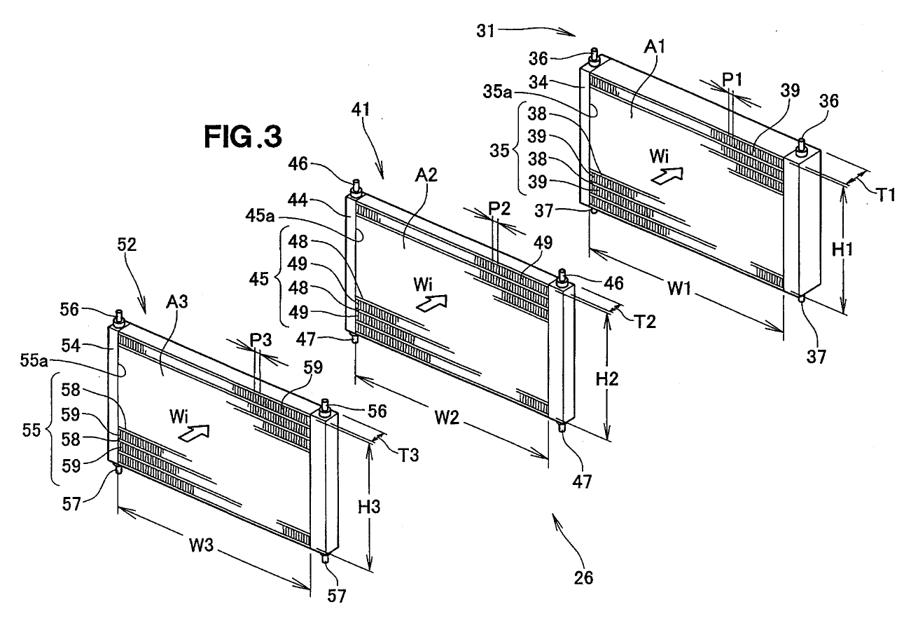

The first radiator 31 is composed of a substantially rectangular frame 34 (composed of a header or the like) as viewed from the front, and a core 35 that is enclosed by the frame 34, as shown in FIG. 3. The frame 34 is provided with a pair of upper-portion support pins 36 and 36 on the left and right extending upward from the left and right ends of the upper surface, and a pair of lower-portion support pins 37 and 37 on the left and right extending downward from the left and right ends of the lower surface. The core 35 is composed of a large number of coolant tubes 38 and a large number of heat-releasing fins 39 (hereinafter referred to as “first heat-releasing fins 39”) that are integrally provided to the external peripheral surface of the large number of coolant tubes 38. The first heat-releasing fins 39 have a corrugated or plate-like shape. The reference numeral P1 is the pitch of the first heat-releasing fins 39, and A1 is the heat-releasing surface area of the heat-releasing fins 39, i.e., the heat-releasing surface area of the first radiator 31. The size of the ventilation apertures 35a of the first radiator 31, i.e., the size of the core 35, is defined by the height H1 and the width W1, and T1 is the thickness of the core 35. The surface area of the ventilation apertures 35a of the first radiator 31, i.e., the surface area A1 of the core 35, can be calculated by using the multiplication formula A1=H1×W1.

The second radiator 41 is composed of a substantially rectangular frame 44 (composed of a header or the like) as viewed from the front, and a core 45 that is enclosed by the frame 44. The frame 44 is provided with a pair of upper-portion support pins 46 and 46 on the left and right extending upward from the left and right ends of the upper surface, and a pair of lower-portion support pins 47 and 47 on the left and right extending downward from the left and right ends of the lower surface. The core 45 is composed of a large number of coolant tubes 48 and a large number of heat-releasing fins 49 (hereinafter referred to as “second heat-releasing fins 49”) that are integrally provided to the external peripheral surface of the large number of coolant tubes 48. The second heat-releasing fins 49 have a corrugated or plate-like shape. The reference numeral P2 is the pitch of the second heat-releasing fins 49, and A2 is the heat-releasing surface area of the heat-releasing fins 49, i.e., the heat-releasing surface area of the second radiator 41. The size of the ventilation apertures 45a of the second radiator 41, i.e., the size of the core 45, is defined by the height H2 and the width W2, and T2 is the thickness of the core 45. The surface area A2 of the core 45 can be calculated by using the multiplication formula A2=H2×W2.

The third radiator 52 is composed of a substantially rectangular frame 54 (composed of a header or the like) as viewed from the front, and a core 55 that is enclosed by the frame 54. The frame 54 is provided with a pair of upper-portion support pins 56 and 56 on the left and right extending upward from the left and right ends of the upper surface, and a pair of lower-portion support pins 57 and 57 on the left and right extending downward from the left and right ends of the lower surface. The core 55 is composed of a large number of coolant tubes 58 and a large number of heat-releasing fins 59 (hereinafter referred to as “third heat-releasing fins 59”) that are integrally provided to the external peripheral surface of the large number of coolant tubes 58. The third heat-releasing fins 59 have a corrugated or plate-like shape. The reference numeral P3 is the pitch of the third heat-releasing fins 59, and A3 is the heat-releasing surface area of the heat-releasing fins 59, i.e., the heat-releasing surface area of the third radiator 52. The size of the ventilation apertures 55a of the third radiator 52, i.e., the size of the core 55, is defined by the height H3 and the width W3, and T3 is the thickness of the core 55. The surface area A3 of the core 55 can be calculated by using the multiplication formula A3=H3×W3.

The sizes (heights and widths) of the ventilation apertures of the first radiator 31, second radiator 41, and third radiator 52 are set to be substantially equal to each other including being identical). In other words, the heights are H1≅H2≅H3 (including H1=H2=H3), and the widths are W1≅W2≅W3 (including W1=W2=W3)

The thickness T1 of the first radiator 31 is greater than the thickness T3 of the third radiator 52, and the thickness T3 of the third radiator 52 is greater than the thickness T2 of the second radiator 41 (T1>T3>T2). The pitch P3 of the third heat-releasing fins 59 is greater than the pitch P1 of the first heat-releasing fins 39, and the pitch P2 of the second heat-releasing fins 49 is greater than the pitch P3 of the third heat-releasing fins 59 (P1<P3<P2).

The heat-releasing surface areas A1, A2, and A3 are determined in accordance with the size of the pitches P1, P2, and P3 of the heat-releasing fins 39, 49, and 59. In other words, since the pitches have the following relationship “P1<P3<P2”, the heat-releasing surface areas have the following relationship “A1>A3>A2”. For example, the pitch P2 of the second heat-releasing fins 49 is set to be greater than the pitch P1 of the first heat-releasing fins 39 (P1<P2). As a result, the heat-releasing surface area A2 of the second radiator 41 is set to be less than the heat-releasing surface area A1 of the first radiator 31 (A1>A2).

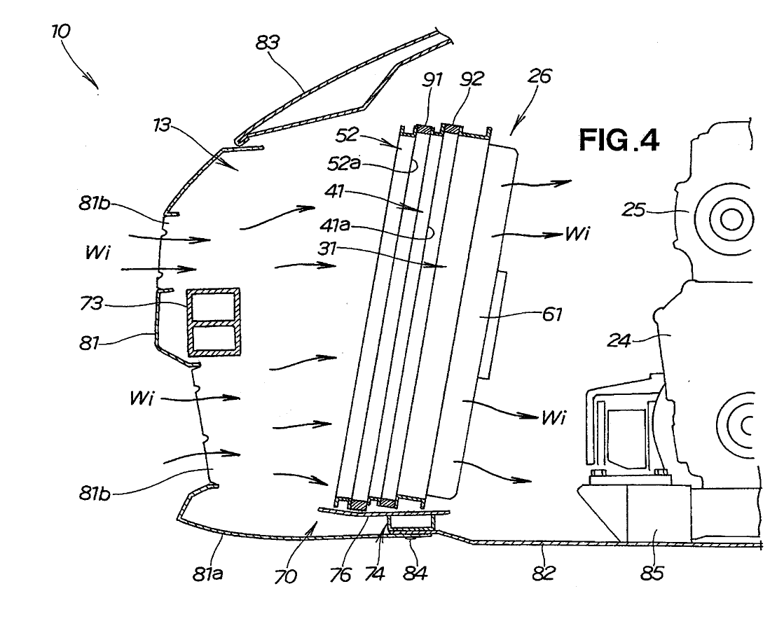

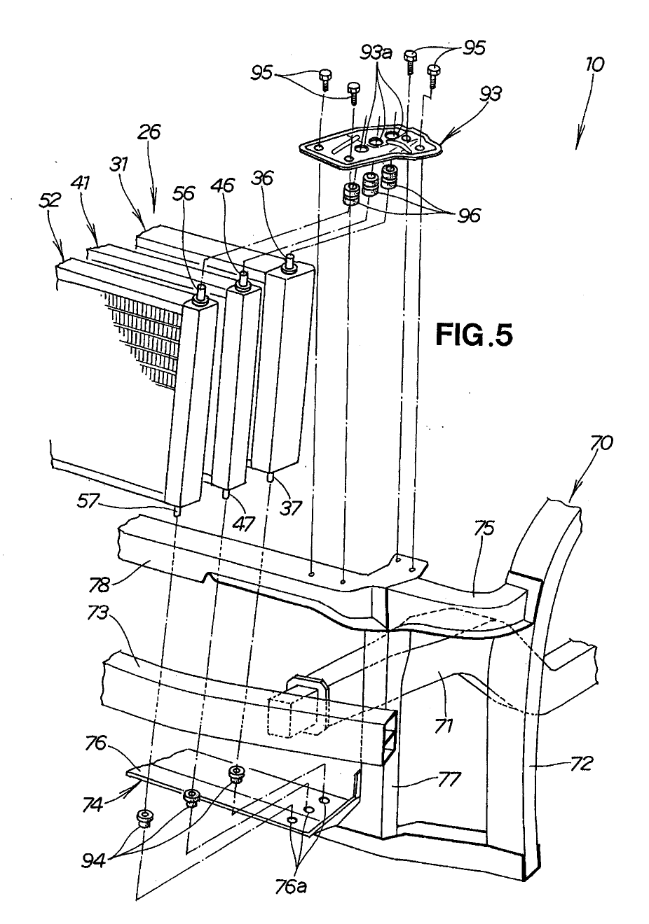

The chassis 70 in the fuel cell vehicle 10 is composed of a monocoque body, as shown in FIGS. 4 and 5. The front portion of the chassis 70 has as the main constituent members left and right front side frames 71 (only the left side is shown, and same applies hereinbelow), left and right front upper members 72, a front bumper beam 73, a front bulkhead 74, and left and right upper side members 75.

The front side frames 71 extend in the front-rear direction of the chassis on the left and right side positions of the front portion of the chassis. The front upper members 72 extend from the front pillar (not shown) while curving forward and downward. The front bumper beam 73 is a horizontal member that is suspended across the front ends of the left and right front side frames 71. The front bulkhead 74 is a member that is joined to the left and right front ends of the front side frames 71. The upper side members 75 are horizontal members that are suspended across the front ends of the front upper members 72.

More specifically, the front bulkhead 74 is a substantially rectangular frame body as viewed from the front, and is composed of a lower cross member 76 disposed on the lower side horizontally in the width direction of the vehicle, a pair of vertical left and right side stays 77, and an upper cross member 78 disposed on the upper side horizontally in the width direction of the vehicle. The lower cross member 76 is a cross member suspended across the lower fronts of the left and right front upper members 72 and used as a support member for supporting the lower portions of the first, second, and third radiators 31, 41, and 52. The side stays 77 are members that are joined to the front portions of the front side frames 71.

The fuel cell vehicle 10 is provided with a bumper face 81 for covering the front of the chassis 70, an undercover 82 for covering the front lower surface of the chassis 70, and an openable hood 83 for covering the apertures of the front upper surface of the chassis 70, as shown in FIG. 4. A power plant compartment 13 is formed in the front portion of the chassis 70 by providing a space enclosed by the members 81 to 83, and other components.

The bumper face 81 has a lower cover portion 81a that extends from the lower end in the rearward direction. The rear end portion of the lower cover portion 81a is superimposed on the lower surface of the lower cross member 76 and is detachably mounted by using clips, machine screws, or other fastening members 84. The bumper face 81 has on its front surface air intake ports 81b and 81b for introducing cooling air (Wi) including wind created by traveling). The undercover 82 is configured with its front end portion superimposed on the lower surface of the lower cross member 76, and is mounted with fastening members 84 on the lower cross member 76 together with the rear end portion of the bumper face 81.

Described next in greater detail is the placement and mounting structure of the first, second, and third radiators 31, 41, and 52.

The first, second, and third radiators 31, 41, and 52 are disposed adjacent to each other in the front-rear direction of the vehicle in the position of the front bulkhead 74 or a position in the vicinity of the front bulkhead, as shown in FIGS. 4 to 6. The drive motor 24 is disposed behind the three radiators 31, 41, and 52, and is mounted on the chassis 70 via a subframe 85, as shown in FIG. 4.

More specifically, the second radiator 41 is disposed adjacent in the front-rear direction to the rear surface 52a of the third radiator 52, which is in the frontmost position, as shown in FIG. 4. The periphery between the third radiator 52 and second radiator 41 is sealed with a seal member 91. In other words, the area between the mutually adjacent surfaces of the third and second radiators 52 and 41 is sealed. Cooling air Wi is therefore prevented from leaking from between the second and third radiators 41 and 52.

In a similar fashion, the first radiator 31 is disposed adjacent to the rear surface 41a of the second radiator 41. The periphery between the second radiator 41 and first radiator 31 is sealed with a seal member 92. In other words, the area between the mutually adjacent surfaces of the second and first radiators 41 and 31 is sealed. Cooling air Wi is therefore prevented from leaking from between the first and second radiators 31 and 41.

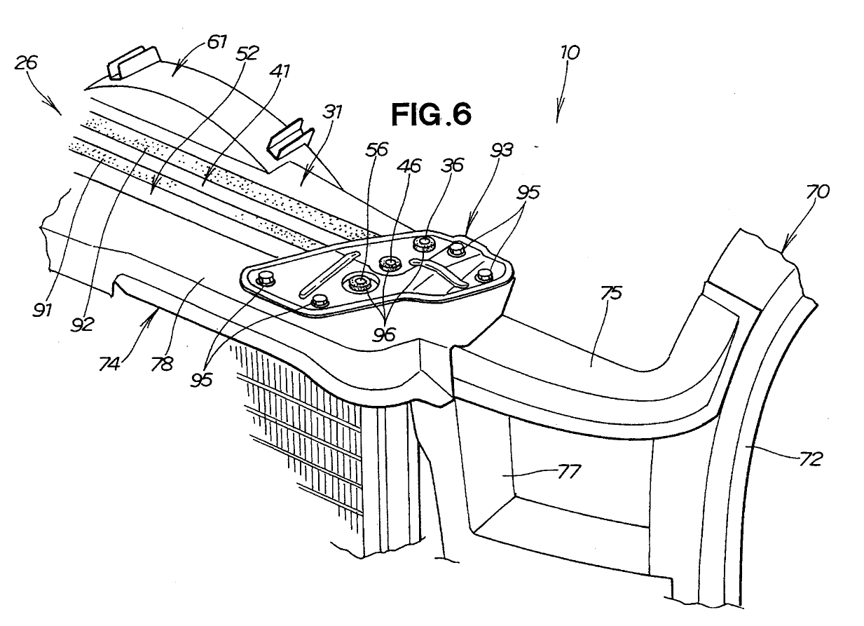

The first, second, and third radiators 31, 41, and 52 are configured with the lower portions directly mounted on the lower cross member 76 and with the upper portions mounted on the upper cross member 78 by using a linking member 93, as shown in FIGS. 5 and 6.

More specifically, the lower support pin 37 of the first radiator 31, the lower support pin 47 of the second radiator 41, and the lower support pin 57 of the third radiator 52 are mounted by being inserted in a plurality of support holes 76a of the lower cross member 76 via mounting bushes 94 on each of the lower sides. The lower cross arm 76 can therefore support the lower end portions of the first, second, and third radiators 31, 41, and 52.

The linking member 93 is a member in the form of a flat plate composed of a press-formed copper plate, is superimposed from above on the left and right end portions of the upper cross member 78, and is detachably mounted using a plurality of bolts 95. The linking member 93 has three support holes 93a that completely pass through the member in the vertical direction. The upper support pin 36 of the first radiator 31, the upper support pin 46 of the second radiator 41, and the upper support pin 56 of the third radiator 52 can be installed by being inserted into the plurality of support holes 93a of the linking member 93 by way of the mounting bushes 96 of the upper sides thereof. The upper end portions of the first, second, and third radiators 31, 41, and 52 can be detachably mounted on the upper cross member 78. This is achieved by a method in which the linking member 93 in which the upper support pins 36, 46, and 56 have been incorporated is mounted on the upper cross member 78.

The first, second, and third radiators 31, 41, and 52 can be adequately supported by the chassis 70 because of such a mounting structure.

The lower end portions of the first, second, and third radiators 31, 41, and 52 may have the same mounting structure as the upper end portions described above.

Described next is the effect of the cooling apparatus 26 for a fuel cell vehicle thus configured.

Cooling air Wi can be taken in from the forward direction of the fuel cell vehicle 10 by driving the radiator air-cooling fan 61, as shown in FIG. 1. The wind produced by traveling (a portion of the cooling air Wi) can be taken in from the forward direction of the fuel cell vehicle 10 by causing the fuel cell vehicle 10 to travel in the forward direction.

When the cooling air Wi passes through the third radiator 52, second radiator 41, and first radiator 31 in the stated order, the cooling air exchanges heat with each of the coolants and is thereafter exhausted to the exterior by the radiator air-cooling fan 61. The operating temperature Te1 of the fuel cell 23, the operating temperature Te2 of the drive motor 24, and operating temperature Te3 of the compressor 51 can therefore be kept at a suitable level via the respective coolants, as shown FIG. 2.

A summary of the above description is provided below.

The cooling apparatus 26 for a fuel cell vehicle is provided with a fuel cell 23, a drive motor 24, a first radiator 31, and a second radiator 41, as shown in FIGS. 2 and 3. The sizes H1 and W1 of the ventilation apertures 35a of the first radiator 31, and the sizes H2 and W2 of the ventilation apertures 45a of the second radiator 41 are set to be substantially equal to each other, the heat-releasing surface areas A1 and A2 of the first and second radiators 31 and 41 are set so as to be different from each other, and the first and second radiators 31 and 41 are disposed adjacent to each other in the front-rear direction of the vehicle.

In other words, the cooling apparatus 26 for a fuel cell vehicle is configured so that the sizes of the ventilation apertures 35a of the first and second radiators 31 and 41 are set to be substantially equal to each other, the pitch P2 of the second heat-releasing fins 49 provided to the second radiator 41 is set to be greater than the pitch P1 of the of the first heat-releasing fins 39 provided to the first radiator 31, and the heat-releasing surface area A2 of the second radiator 41 is set to be less than the heat-releasing surface area A1 of the first radiator 31.

Therefore, (1) the size of the ventilation apertures 35a and the heat-releasing surface area A1 are first established for the first radiator 31 that cools the coolant for the fuel cell 23, which releases a considerable amount of heat, (2) the size of the ventilation apertures 45a of the second radiator 41 for cooling the coolant of the drive motor 24, which releases a lower amount of heat, is thereafter set in accordance with the ventilation apertures 35a of the first radiator 31, and (3) the heat-releasing surface area A2 of the second radiator 41 can be set to a size that corresponds to the amount of heat released by the drive motor 24.

More specifically, the sizes of the ventilation apertures 35a and 45a of the first and second radiators 31 and 41 can be set to be essentially equal to each other, and the pitches P1 and P2 of the heat-releasing fins 39 and 49 in the first and second radiators 31 and 41 can be individually set so that the heat-releasing surface areas A1 and A2 of the first and second radiators 31 and 41 can each be set so as to achieve an optimal size. The second radiator 41 is therefore disposed in the front portion of the fuel cell vehicle 10 (see FIG. 1), and the pressure loss (ventilation resistance) of the cooling wind Wi that passes through the first and second radiators 31 and 41 is dramatically reduced despite the fact that the first radiator 31 is disposed adjacent to the rear surface of the second radiator 41.

The sizes of the ventilation apertures 35a and 45a of the first and second radiators 31 and 41 are furthermore set to be substantially equal to each other. Therefore, the periphery between the adjacent surfaces, i.e., the periphery between the first and second radiators 31 and 41, can be reliably and readily sealed with a seal member 92 (see FIG. 2) by placing the first and second radiators 31 and 41 adjacent in the front-back direction of the vehicle. As a result, cooling air Wi can be prevented from leaking from between the first and second radiators 31 and 41.

Moreover, since the first and second radiators 31 and 41 are disposed in the front portion of the fuel cell vehicle 10, the wind Wi that is created when the fuel cell vehicle 10 travels can be used effectively, as shown in FIG. 1.

As a result of the above, an adequate amount of cooling air Wi required for releasing heat can be obtained with the first and second radiators 31 and 41.

Also, since the first and second radiators 31 and 41 are adjacent in the front-back direction of the vehicle, the installation space of the radiators 31 and 41 can be kept low. For this reason, the first and second radiators 31 and 41 can be easily disposed in the narrow space of the front portion of a fuel cell vehicle 10. A plurality of radiators 31 and 41 can therefore be disposed in a small installation space, and the fuel cells 23 and drive motor 24 can be cooled with good efficiency.

Further space-savings can be assured because the radiator air-cooling fan 61 for feeding cool air Wi to the first and second radiators 31 and 41 is shared by the first and second radiators 31 and 41, and is mounted behind the first radiator 31.

The first radiator 31 is disposed behind the second radiator 41, and the cooling performance of the second radiator 41 is therefore unaffected by the heat released from the first radiator 31. The operating temperature Te2 of the drive motor 24 is lower than the operating temperature Te1 of the fuel cell 23, as shown in FIG. 2. For this reason, the cooling capacity of the second radiator 41 can be reduced.

Also, since the third radiator 52 is disposed in front of the first and second radiators 31 and 41, as shown in FIG. 1, the third radiator 52 can be easily disposed together with the first and second radiators 31 and 41 in the narrow space of the front portion of a fuel cell vehicle (in other words, the power plant compartment 13).

The size H3, W3 of the ventilation apertures 55a of the third radiator 52 and the sizes of the ventilation apertures 35a and 45a of the first and second radiators 31 and 41 are set to be substantially the same, as shown in FIGS. 2 and 3. Therefore, the periphery between the third radiator 52 and the first and second radiators 31 and 41 can be easily and reliably sealed with a seal member 91 (see FIG. 2) by placing the third radiator 52 adjacent to the first and second radiators 31 and 41. As a result, leakage of cooling air Wi from between the third radiator 52 and the first and second radiators 31 and 41 can be prevented. Because of the above, the required amount of cooling air Wi for releasing the heat of the first, second, and third radiators 31, 41, and 52 can be sufficiently assured.

Moreover, since the radiator air-cooling fan 61 doubles as a fan for feeding cooling air to the third radiator 52, an air cooling fan is not required to be separately provided for the third radiator 52. For this reason, further space-savings can be ensured.

In the present invention, any shape, dimensions, material, and mounting structure may be used for the seal members 91 and 92.

The cooling apparatus 26 for a fuel cell vehicle of the present invention is advantageously used to cool with good efficiency a fuel cell 23 and drive motor 24 mounted in a fuel cell vehicle 10.

Obviously, various minor changes and modifications of the present invention are possible in the light of the above teaching. It is therefore to be understood that within the scope of the appended claims the invention may be practiced otherwise than as specifically described.

What is claimed is:

1. A cooling apparatus for a fuel cell vehicle, comprising:
a coolant-cooling first radiator for cooling a fuel cell, the first radiator having ventilation apertures and a heat-releasing surface area;
a coolant-cooling second radiator for cooling a drive motor that receives electric power from said fuel cell and generates traveling motive power, the second radiator having ventilation apertures and a heat-releasing surface area; and
a common radiator air-cooling fan for supplying cooling air to both the first and second radiators;
wherein the ventilation apertures of the first radiator and the ventilation apertures of the second radiator are set to be substantially the same in size,
the heat-releasing surface area of the first radiator and the heat-releasing surface area of the second radiator are set to be different from each other,
the first and second radiators are capable of being disposed adjacent to each other forward of the fuel cell vehicle in the front-rear direction of the vehicle, and
a periphery between the first radiator and the second radiator is sealed with a sealing member.

2. The cooling apparatus of claim 1, wherein an operating temperature of the fuel cell is set to a higher level than is an operating temperature of the chive motor, and the first radiator is disposed behind the second radiator.

3. The cooling apparatus of claim 1, further comprising a coolant-cooling third radiator for an interior air conditioner of the fuel cell vehicle, wherein the third radiator is disposed in front of the first and second radiators and has ventilation apertures which are sized substantially the same as the ventilation apertures of the first and second radiators, and the common radiator air-cooling fan supplies cooling air to the third radiator.

4. The cooling apparatus of claim 3, wherein the third radiator has a thickness set to be smaller than a thickness of the first radiator, and the second radiator has a thickness set to be smaller than the thickness of the third radiator.

5. The cooling apparatus of claim 3, wherein each of the first, second, and third radiators comprises a pair of lower-portion support pins on the left and right extending downward from the left end and the right end, and a pair of upper-portion support pins on the left and right extending upward from the left end and the right end, the pairs of the lower-portion support pins in the first, second, and third radiators are capable of being mounted on the chassis by fitting into a plurality of support holes that are provided to the chassis in the fuel cell vehicle, and the pairs of the upper-portion support pins in the first, second, and third radiators are capable of being mounted on the chassis by fitting into a plurality of support holes that are provided to a detachable linking member mounted on the chassis.

6. A cooling apparatus for a fuel cell vehicle, comprising:
a coolant-cooling first radiator for cooling a fuel cell, the first radiator having ventilation apertures and a heat-releasing surface area;
a coolant-cooling second radiator for cooling a drive motor that receives electric power from said fuel cell and generates traveling motive power, the second radiator having ventilation apertures and a heat-releasing surface area; and
a common radiator air-cooling fan, wherein
the ventilation apertures of the first radiator and the ventilation apertures of the second radiator are set to be substantially the same in size,
the heat-releasing surface area of the second radiator is set to be smaller than the heat-releasing surface area of the first radiator by setting a pitch of heat-releasing fins provided to the second radiator to be greater than a pitch of heat-releasing fins provided to the first radiator,
the first and second radiators are capable of being disposed in front of the fuel cell vehicle,
the first radiator is disposed adjacent to a rear surface of the second radiator,
a periphery between the first radiator and the second radiator is sealed with a sealing member, and
the common radiator air-cooling fan supplies cooling air to both the first and second radiators by being mounted rearward of the first radiator.

7. The cooling apparatus of claim 6, further comprising a coolant-cooling third radiator for an interior air conditioner of the fuel cell vehicle, wherein the third radiator is disposed in front of the first and second radiators, the ventilation apertures of the third radiator are sized to be substantially the same as the ventilation apertures of the first and second radiators, and the radiator air-cooling fan supplies cooling air to the third radiator.

8. The cooling apparatus of claim 7, wherein the third radiator has a thickness set to be smaller than a thickness of the first radiator, and the second radiator has a thickness set to be smaller than the thickness of the third radiator.

9. The cooling apparatus of claim 7, wherein each of the first, second, and third radiators comprises a pair of lower-portion support pins on the left and right extending downward from the left end and the right end, and a pair of upper-portion support pins on the left and right extending upward from the left end and the right end, the pairs of lower-portion support pins in the first, second, and third radiators are capable of being mounted on the chassis by fitting into a plurality of support holes that are provided to the chassis in the fuel cell vehicle, and the pairs of the upper-portion support pins in the first, second, and third radiators are capable of being mounted on the chassis by fitting into a plurality of support holes that are provided to a detachable linking member mounted on the chassis.
